(19) United States
(12) Patent Application Publication
(10) Pub. No.: US 2008/0304773 A1
(43) Pub. Date: Dec. 11, 2008

(54) Linear motion guide apparatus

(75) Inventors: Tsung Jen Chen, Taichung (TW); Min Yao Hsieh, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/810,319

(22) Filed: Jun. 5, 2007

(51) Int. Cl. F16C 29/08

(52) U.S. Cl. 384/15

(57) ABSTRACT

A linear motion guide device includes a slider slidably attached onto a guide rail, an end cap attached to each side of the slider, a cover band engaged onto the upper portion of the guide rail and having an end portion extended out of the end portion of the guide rail, and a block attached to the end portion of the guide rail and having an opening for receiving the end portion of the cover band, a wedge member is slidably engaged into the opening of the block and includes an inclined surface for slidably engaging with the inclined surface of the block and for securing the end portion of the cover band to the block when the wedge member is engaged into the opening of the block, a fastener may force the wedge member to secure the end portion of the cover band to the block.

### BACKGROUND OF THE INVENTION

1. Field of the Invention

The present invention relates to a linear motion guide apparatus, and more particularly to a linear motion guide apparatus including a cover band securing device attached to the end portions of the longitudinal guide rail without affecting or reducing the moving stroke or the movement of the slider.

2. Description of the Prior Art

Typical linear motion guide devices comprise a slider or slide block slidably attached onto a guide rail, and normally, a ball bearing device disposed between the slider and the guide rail for facilitating the sliding movement between the slider and the guide rail and for allowing the slider and the guide rail to be smoothly moved relative to each other.

For example, U.S. Pat. No. 7,121,724 to Lee et al. discloses one of the typical linear motion rolling guide units comprising a slider or slide block slidably attached onto a guide rail, and one or more end caps attached onto the slide block. Normally, the guide rail will be drilled with one or more holes therein for engaging with the latches or fasteners and for securing the guide rail and thus the slide block onto the supporting objects or machines or higher modular unit.

However, the holes formed in the guide rail may not be suitably shielded or covered such that dust or particles or contaminants may enter into the holes of the guide rail and may affect or spoil the movement of the slider block relative to the guide rail.

U.S. Pat. No. 6,513,976 to Maiss et al. discloses another typical linear motion rolling guide device also comprising a slider or slide block slidably attached onto a guide rail, a surface of the guide rail facing the slider or slide block is covered with a cover band, and a band securing element is placed in the vicinity of each of the two longitudinal ends of the guide rail for non-positively engaging with the cover band.

However, the band securing elements are attached to the vicinity of the ends of the guide rail or engaged onto the guide rail, such that the moving distance of the slider block relative to the guide rail will be decreased, and such that the movement of the slider block relative to the guide rail will be affected by the band securing elements.

The present invention has arisen to mitigate and/or obviate the afore-described disadvantages of the conventional linear motion guide devices.

### SUMMARY OF THE INVENTION

The primary objective of the present invention is to provide a linear motion guide apparatus including a cover band securing device attached to the end portions of the longitudinal guide rail without affecting or reducing the moving stroke or the movement of the slider.

The other objective of the present invention is to provide a linear motion guide apparatus including a cover band securing device for solidly and positively securing the cover band to the guide rail.

In accordance with one aspect of the invention, there is provided a linear motion guide apparatus comprising a guide rail including an end portion and including an upper portion, a slider slidably attached onto the guide rail for moving along the guide rail, a cover band engaged onto the upper portion of the guide rail and including an end portion extended out of the end portion of the guide rail, a block attached to the end portion of the guide rail and including an opening formed therein for receiving the end portion of the cover band, the block including an inclined surface, a wedge member slidably engaged into the opening of the block and including an inclined surface for slidably engaging with the inclined surface of the block and for securing the end portion of the cover band to the block when the wedge member is engaged into the opening of the block, and a forcing device for forcing the wedge member to engage into the opening of the block and to secure the end portion of the cover band to the block.

The forcing device includes a fastener engaged with the wedge member for forcing and moving the wedge member to engage into the opening of the block and to secure the end portion of the cover band to the block.

The block includes a partition for forming the opening of the block, and a passage formed in the partition of the block for receiving the fastener.

The block includes a slot formed in the partition and communicating with the opening of the block for receiving the end portion of the cover band. The slot is preferably formed through the block.

The guide rail includes a longitudinal recess formed in the upper portion thereof for receiving the cover band. The guide rail includes at least one orifice formed therein and communicating with the longitudinal recess of the guide rail for receiving a fastener, the cover band shields the orifice of the guide rail.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a linear motion guide apparatus in accordance with the present invention;

FIG. 2 is a partial perspective view of the linear motion guide apparatus;

FIG. 3 is a partial exploded view of the linear motion guide apparatus;

FIG. 4 is a partial cross sectional view taken along lines 4-4 of FIG. 2;

FIG. 5 is another partial cross sectional view similar to FIG. 4, illustrating the other arrangement of the linear motion guide apparatus;

FIG. 6 is another partial exploded view of the linear motion guide apparatus;

FIG. 7 is a partial cross sectional view taken along lines 7-7 of FIG. 6;

FIG. 8 is a partial cross sectional view taken along lines 8-8 of FIG. 2;

FIG. 9 is another partial perspective view of the linear motion guide apparatus;

FIG. 10 is a further partial exploded view of the linear motion guide apparatus;

FIG. 11 is a perspective view similar to FIG. 1, illustrating the further arrangement of the linear motion guide apparatus;

FIG. 12 is a partial perspective view of the linear motion guide apparatus as shown in FIG. 11;

FIG. 13 is a partial exploded view of the linear motion guide apparatus as shown in FIGS. 11 and 12;

FIG. 14 is a partial cross sectional view taken along lines 14-14 of FIG. 1 1;

FIG. 15 is another partial cross sectional view similar to FIG. 14, illustrating the further arrangement of the linear motion guide apparatus;

FIG. 16 is a further partial perspective views similar to FIG. 12, illustrating the assembling operation of the linear motion guide apparatus; and

FIG. 17 is a still further partial exploded view of the linear motion guide apparatus as shown in FIGS. 11-16.

### DETAILED DESCRIPTION OF THE PREFERRED EMBODIMENT

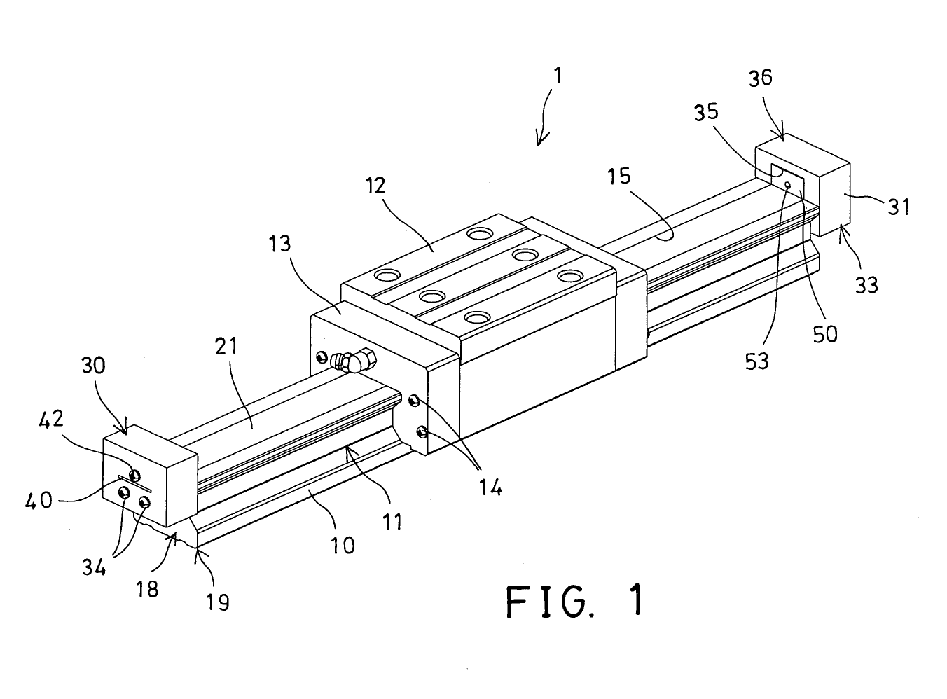

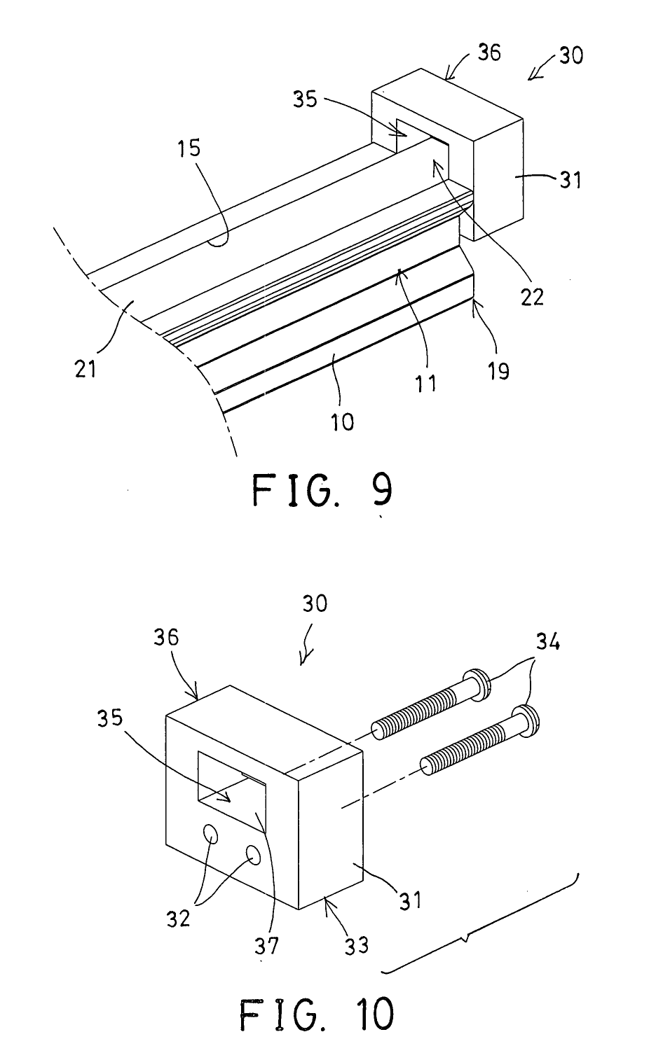

Referring to the drawings, and initially to FIG. 1, a linear motion guide apparatus 1 in accordance with the present invention comprises a guide rail 10 including a substantially I-shaped cross section having two longitudinal recesses 11 formed in the side portions thereof (FIGS. 1-2, 6-9), and a slide block or a slider 12 slidably attached onto the guide rail 10 and arranged to be moved along the guide rail 10, and normally, a ball bearing device (not shown) disposed between the slider 12 and the guide rail 10 for facilitating the sliding movement between the slider 12 and the guide rail 10 and for allowing the slider 12 and the guide rail 10 to be smoothly moved relative to each other. Two end caps 13 are disposed on the two sides or end portions or outer portions of the slider 12 and attached or secured to the slider 12 with such as fasteners 14 respectively.

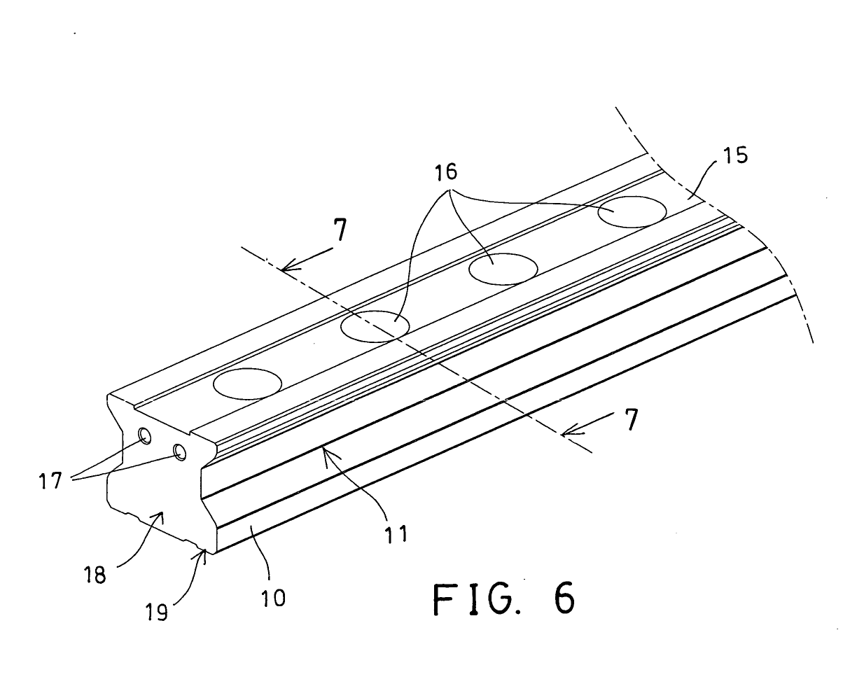

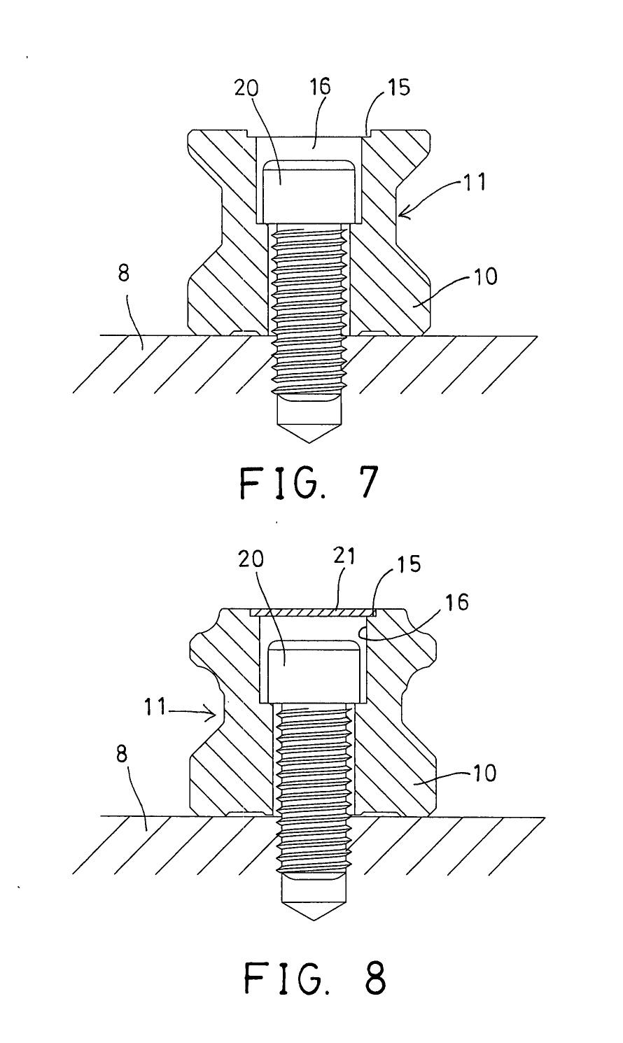

As shown in FIGS. 1-2, 6-9, the guide rail 10 includes a longitudinal recess 15 formed in the upper and center portion thereof (FIG. 6) and preferably formed through the length of the guide rail 10, and includes one or more holes or orifices 16 formed therein, such as formed in the upper and center portion thereof (FIG. 6) and communicating with the longitudinal recess 15 of the guide rail 10 for receiving or engaging with fasteners 20 (FIGS. 7-8) which may be threaded or engaged with the supporting objects or machines or higher modular unit 8 for solidly securing the guide rail 10 to the supporting objects or machines or higher modular unit 8. The ball bearing device (not shown) and the slider 12 and the end caps 13 and the fasteners 20 are not related to the present invention and will not be described in further details. The guide rail 10 includes one or more (such as two) cavities 17 formed in each of the end surfaces 18 of the end portions 19 that are preferably perpendicular to the guide rail 10 (FIG. 6).

The linear motion guide apparatus 1 in accordance with the present invention further includes a cover band 21 engaged into the recess 15 of the guide rail 10 for shielding or covering the orifices 16 of the guide rail 10 and for preventing dust or particles or contaminants from entering into the orifices 16 of the guide rail 10 and for preventing the dust or particles or contaminants from affecting the movement of the slider block relative to the guide rail, and further includes a cover band securing device 30 (FIGS. 1-5, 9-10) for solidly and positively securing each of the two longitudinal end portions 22 of the cover band 21 to the guide rail 10. As shown in FIGS. 4-5, and 9, the longitudinal end portions 22 of the cover band 21 are extended out of the guide rail 10 and to be secured to the guide rail 10 with the cover band securing device 30 without bending or folding the longitudinal end portions 22 of the cover band 21 relative to the guide rail 10.

The cover band securing devices 30 each include a block 31 having one or more (such as two) apertures 32 formed in the lower portion 33 thereof (FIGS. 3-5, 10) for aligning with the cavities 17 at the end surfaces 18 of the guide rail 10 and for receiving fasteners 34 (FIGS. 1, 10) which may be threaded or engaged with the guide rail 10 for solidly attaching or securing the blocks 31 to the guide rail 10. It is to be noted that the blocks 31 are not engaged onto the side portions of the guide rail 10 and are secured to the outer portions of the end portions 19 of the guide rail 10 such that the attachment of the blocks 31 to the guide rail 10 will not reduce or decrease the moving stroke of the slider 12 along the guide rail 10 and thus will not affect the sliding movement of the slider 12 relative to the guide rail 10. The blocks 31 each further include an opening 35 formed in the upper portion 36 thereof for receiving the longitudinal end portions 22 of the cover band 21 (FIGS. 4-5 and 9).

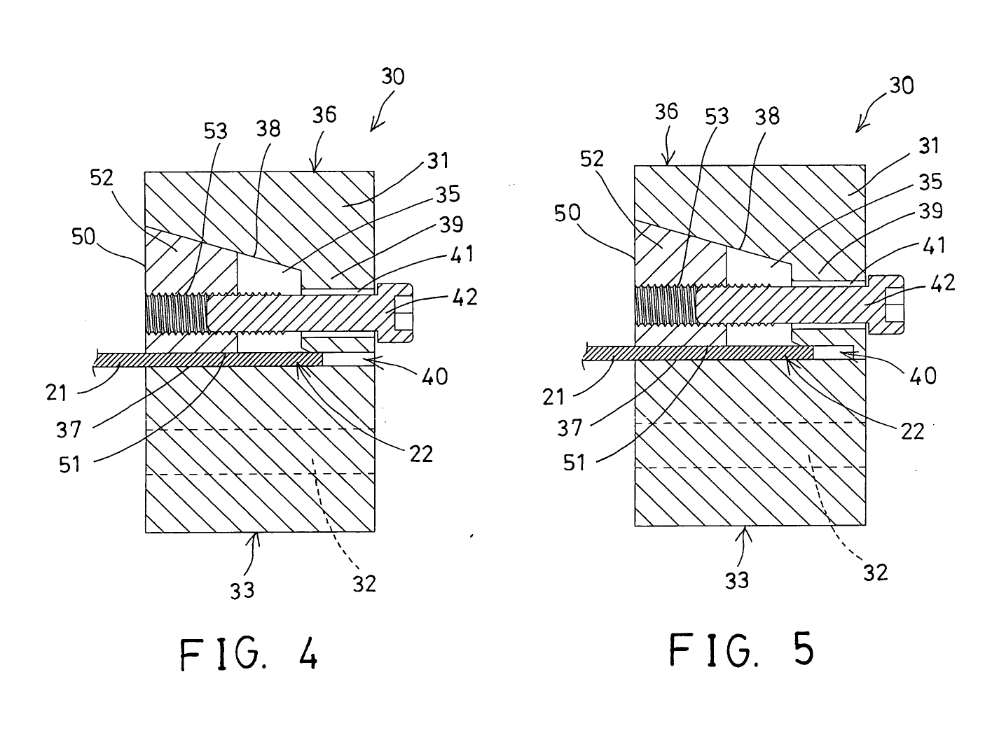

It is preferable that the blocks 31 each include a flat bottom surface 37 and an inclined upper surface 38 and an outer or rear wall or partition 39 (FIGS. 4, 5) for forming or defining the opening 35 of the block 31, and preferably each include a slot 40 formed in the partition 39 and communicating with the respective opening 35 of the block 31 for partially receiving the longitudinal end portions 22 of the cover band 21. The slot 40 may be formed through the block 31 (FIGS. 1, 4) or partially formed in the block 31 (FIG. 5) dependent on the length of the longitudinal end portions 22 of the cover band 21. The flat bottom surface 37 of the block 31 may be provided for flatly supporting the longitudinal end portions 22 of the cover band 21. The blocks 31 each may further include a passage 41 formed through the partition 39 of the block 31 for rotatably receiving fasteners 42 (FIGS. 4-5).

The cover band securing devices 30 each further include a wedge member 50 slidably engaged into the respective opening 35 of the block 31, and the wedge member 50 includes a flat bottom surface 51 for engaging with the longitudinal end portions 22 of the cover band 21, and an inclined upper surface 52 for slidably engaging with the respective inclined upper surface 38 of the block 31, and for solidly securing the longitudinal end portions 22 of the cover band 21 to the block 31 when the wedge member 50 is engaged into the respective opening 35 of the block 31. The wedge members 50 each includes a threaded or screw hole 53 formed therein for threading or engaging with the fastener 42 which may force or move the wedge member 50 to deeply engage into the respective opening 35 of the block 31 and thus to solidly secure the longitudinal end portions 22 of the cover band 21 to the block 31 (FIGS. 1-2, 4-5). The fastener 42 may be acted as a forcing means for forcing and moving the wedge member 50 to deeply engage into the respective opening 35 of the block 31 and to solidly secure the longitudinal end portions 22 of the cover band 21 to the block 31.

It is to be noted that the blocks 31 are extended higher or upper than the guide rail 10 and the opening 35 of the block 31 is located higher than the guide rail 10 for allowing the longitudinal end portions 22 of the cover band 21 to be engaged into the respective opening 35 of the block 31 and to be engaged into the slot 40 of the block 31. Again, the block 31 and wedge member 50 of the cover band securing device 30 are attached to the end surface 18 of the end portion 19 of the guide rail 10, and are not engaged onto the side portions of the guide rail 10 and are secured to the outer portions of the end portions 19 of the guide rail 10 such that the attachment of the blocks 31 to the guide rail 10 will not reduce or decrease the moving stroke of the slider 12 along the guide rail 10 and thus will not affect the sliding movement of the slider 12 relative to the guide rail 10.

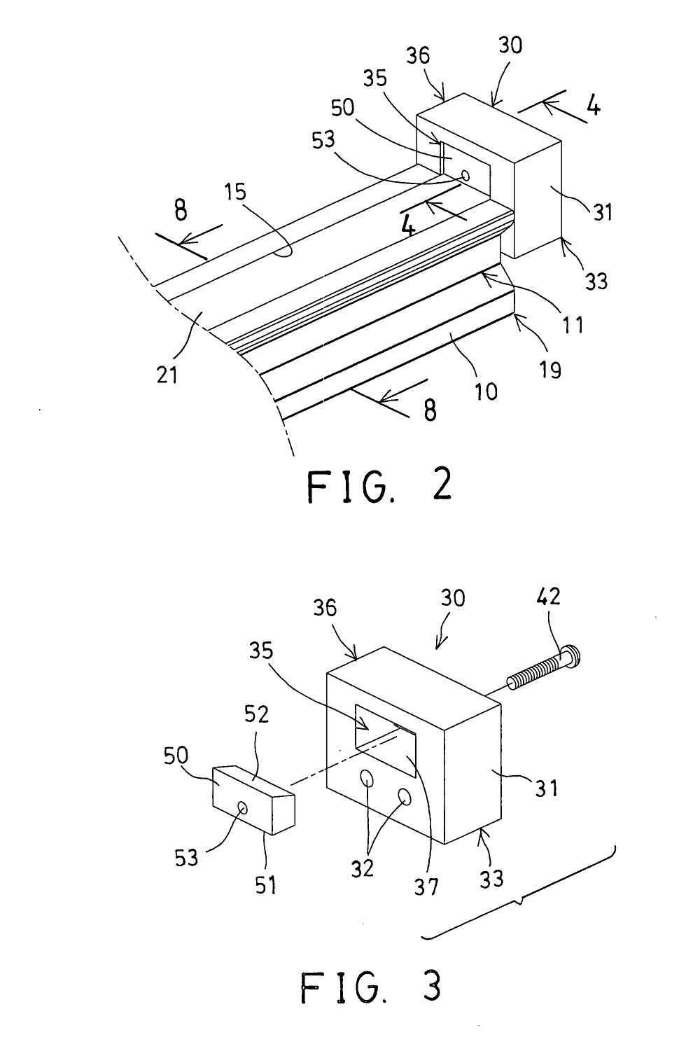

In operation, as shown in FIGS. 1 and 2, the longitudinal end portions 22 of the cover band 21 are extended out of the guide rail 10 and engaged into the respective opening 35 of the block 31, and may be solidly secured to the guide rail 10 with the block 31 and the wedge member 50 of the cover band securing device 30. The blocks 31 will not affect the sliding movement of the slider 12 relative to the guide rail 10, but may be used to limit the slider 12 to move or to slide relative to the guide rail 10 and to prevent the slider 12 from being disengaged form the guide rail 10.

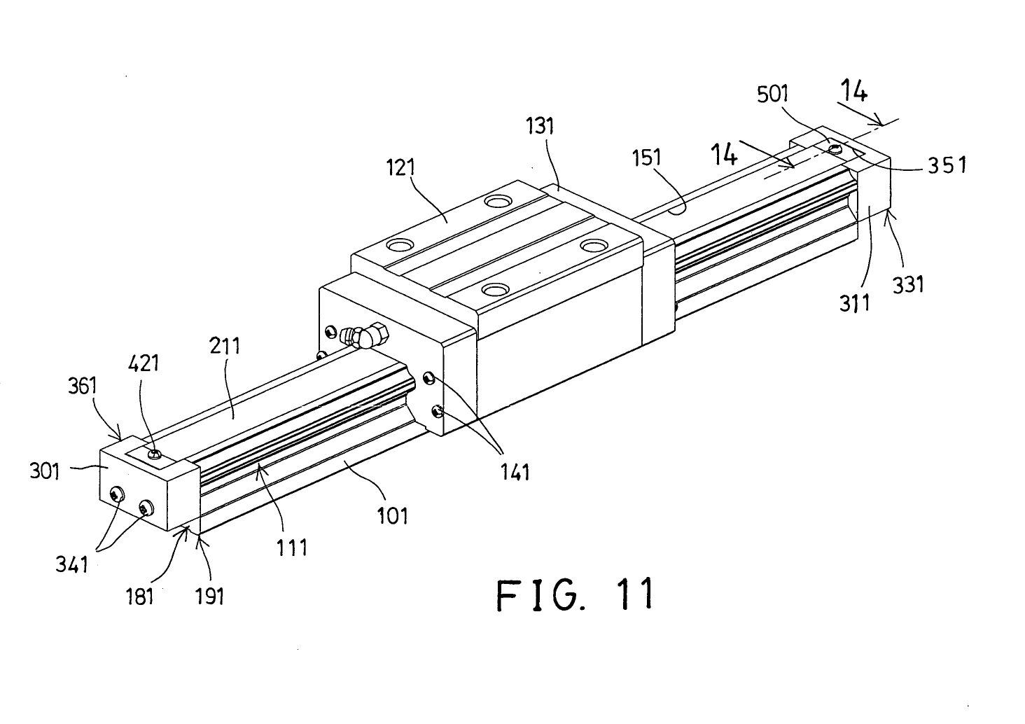

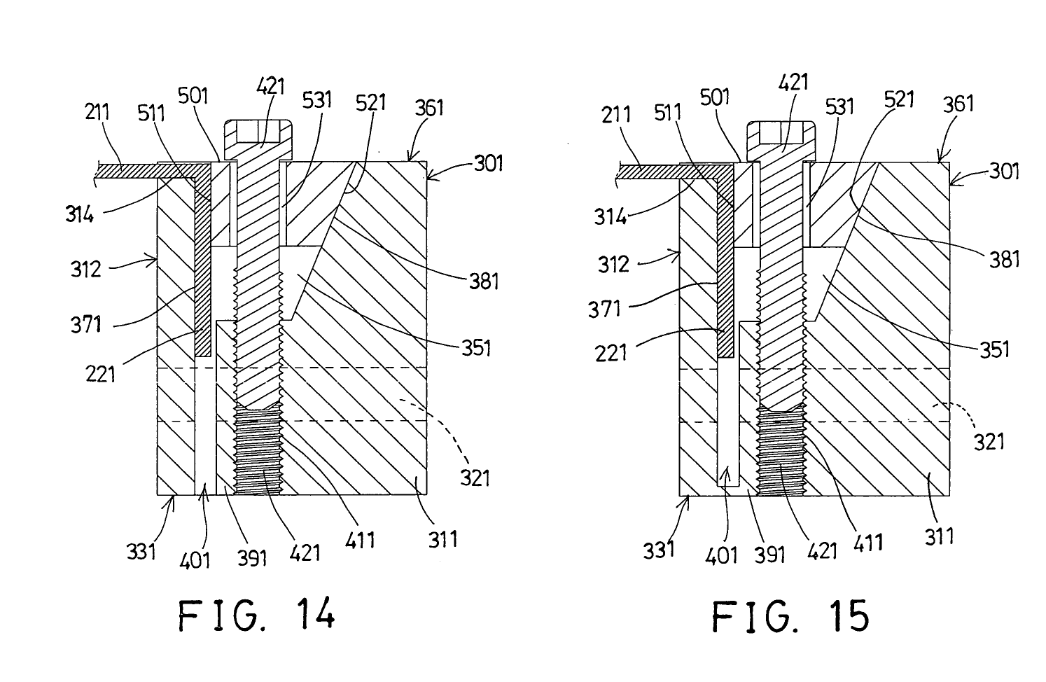

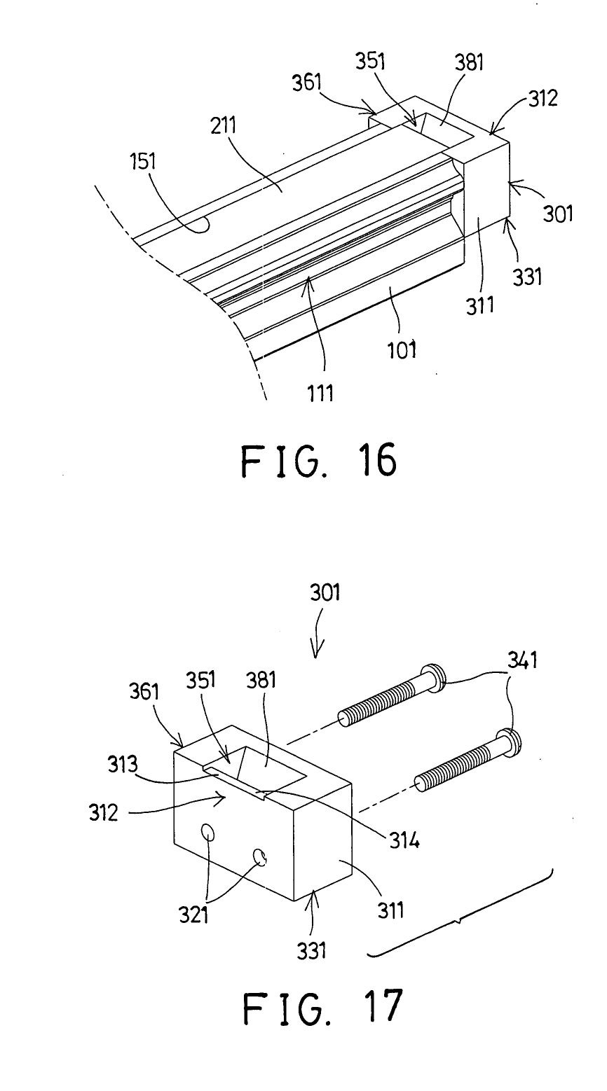

Alternatively, as shown in FIGS. 11-17, a guide rail 101 also includes two longitudinal recesses 111 formed in the side portions (FIGS. 11-12, 16), and a slide block or a slider 121 slidably attached onto the guide rail 101, and two end caps 131 are disposed on the two sides or end portions or outer portions of the slider 121 and attached or secured to the slider 121 with such as fasteners 141 respectively, the guide rail 101 includes a longitudinal recess 151 formed in the upper and center portion thereof. A cover band 211 is engaged into the recess 151 of the guide rail 101, and a cover band securing device 301 is used for solidly and positively securing each of the two longitudinal end portions 221 of the cover band 211 to the guide rail 101 (FIGS. 14-15), in which the longitudinal end portions 221 of the cover band 211 are extended out of the guide rail 101 and bent or folded relative to the guide rail 101 and to be secured to the guide rail 101 with the cover band securing device 301.

The cover band securing devices 301 each include a block 311 having one or more (such as two) apertures 321 formed in the lower portion 331 thereof for receiving fasteners 341 (FIGS. 11) which may be threaded or engaged with the guide rail 101 for solidly securing the blocks 311 to the guide rail 101. It is to be noted that the blocks 311 are not engaged onto the side portions of the guide rail 101 and are secured to the outer portions or the outer end surfaces 181 of the end portions 191 of the guide rail 101 such that the attachment of the blocks 311 to the guide rail 101 will not reduce or decrease the moving stroke of the slider 121 along the guide rail 101 and thus will not affect the sliding movement of the slider 121 relative to the guide rail 101. The blocks 311 each further include an opening 351 formed in the upper portion 361 thereof and defined by an outer peripheral wall 312 for receiving the longitudinal end portions 221 of the cover band 211 (FIGS. 11-12, 14-15).

It is preferable that the blocks 311 each include a flat inner surface 371 and an inclined outer surface 381 and a lower wall or partition 391 (FIGS. 14, 15) for forming or defining the opening 351 of the block 311, and preferably each include a slot 401 formed in the partition 391 and communicating with the respective opening 351 of the block 311 for partially receiving the bent or folded longitudinal end portions 221 of the cover band 211. The slot 401 may be formed through the block 311 (FIGS. 14) or partially formed in the block 311 (FIG. 15) dependent on the length of the longitudinal end portions 221 of the cover band 211. The block 311 includes a notch 313 formed in the outer peripheral wall 312 and communicating with the respective opening 351 of the block 311 and defined by a flat bottom surface 314 for receiving and flatly supporting the longitudinal end portions 221 of the cover band 211. The blocks 311 each may further include a threaded or screw hole 411 formed through the partition 391 of the block 311 for threading or engaging with fasteners 421 (FIGS. 14-15).

The cover band securing devices 301 each further include a wedge member 501 slidably engaged into the respective opening 351 of the block 311, and the wedge member 501 includes a flat inner surface 511 for engaging with the longitudinal end portions 221 of the cover band 211, and an inclined outer surface 521 for slidably engaging with the respective inclined outer surface 381 of the block 311, and for solidly securing the longitudinal end portions 221 of the cover band 211 to the block 311 when the wedge member 501 is engaged into the respective opening 351 of the block 311. The wedge members 501 each includes a passage 531 formed therein for rotatably receiving the fastener 421 which may force or move the wedge member 501 to deeply engage into the respective opening 351 of the block 311 and thus to solidly secure the longitudinal end portions 221 of the cover band 211 to the block 311 (FIGS. 11-12, 14-15).

It is to be noted that the blocks 311 are flush with the upper portion of the guide rail 101 and the opening 351 of the block 311 may be provided for receiving the folded or bent longitudinal end portions 221 of the cover band 211 which may be engaged into the slot 401 of the block 311. Again, the block 311 and wedge member 501 of the cover band securing device 301 are attached to the end surface 181 of the end portion 191 of the guide rail 101, and are not engaged onto the side portions of the guide rail 101 and are secured to the outer portions of the end portions 191 of the guide rail 101 such that the attachment of the blocks 311 to the guide rail 101 will not reduce or decrease the moving stroke of the slider 121 along the guide rail 101 and thus will not affect the sliding movement of the slider 121 relative to the guide rail 101.

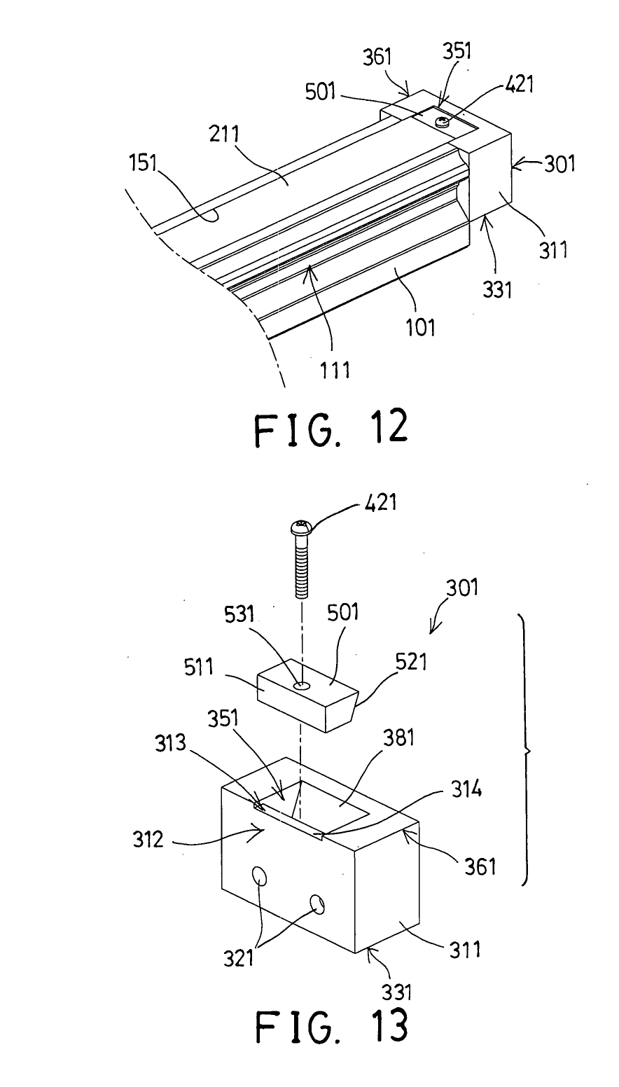

In operation, as shown in FIGS. 11 and 12, the longitudinal end portions 221 of the cover band 211 are extended out of the guide rail 101 and engaged into the respective opening 351 of the block 311, and may be solidly secured to the guide rail 101 with the block 311 and the wedge member 501 of the cover band securing device 301. The blocks 311 will not affect the sliding movement of the slider 121 relative to the guide rail 101, but may be used to limit the slider 121 to move or to slide relative to the guide rail 101 and to prevent the slider 121 from being disengaged form the guide rail 101.

Accordingly, the linear motion guide apparatus in accordance with the present invention includes a cover band securing device attached to the end portions of the longitudinal guide rail without affecting or reducing the moving stroke or the movement of the slider, and for solidly and positively securing the cover band to the guide rail.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide apparatus comprising:
a guide rail including an end portion and including an upper portion,
a slider slidably attached onto said guide rail for moving along said guide rail,
a cover band engaged onto said upper portion of said guide rail and including an end portion extended out of said end portion of said guide rail,
a block attached to said end portion of said guide rail and including an opening formed therein for receiving said end portion of said cover band, said block including an inclined surface,
a wedge member slidably engaged into said opening of said block and including an inclined surface for slidably engaging with said inclined surface of said block and for securing said end portion of said cover band to said block when said wedge member is engaged into said opening of said block, and
means for forcing said wedge member to engage into said opening of said block and to secure said end portion of said cover band to said block.

2. The linear motion guide apparatus as claimed in claim 1, wherein said forcing means includes a fastener engaged with said wedge member for forcing and moving said wedge member to engage into said opening of said block and to secure said end portion of said cover band to said block.

3. The linear motion guide apparatus as claimed in claim 2 wherein said block includes a partition for forming said opening of said block, and a passage formed in said partition of said block for receiving said fastener.

4. The linear motion guide apparatus as claimed in claim 3, wherein said block includes a slot formed in said partition and communicating with said opening of said block for receiving said end portion of said cover band.

5. The linear motion guide apparatus as claimed in claim 4, wherein said slot is formed through said block.

6. The linear motion guide apparatus as claimed in claim 1, wherein said guide rail includes a longitudinal recess formed in said upper portion thereof for receiving said cover band.

7. The linear motion guide apparatus as claimed in claim 6, wherein said guide rail includes at least one orifice formed therein and communicating with said longitudinal recess of said guide rail for receiving a fastener, said cover band shields said at least one orifice of said guide rail.
